(19) United States
(12) Patent Application Publication
(10) Pub. No.: US 2017/0271704 A1
(43) Pub. Date: Sep. 21, 2017

(54) MITIGATION OF CROSSOVER WITHIN FLOW BATTERIES

(71) Applicant: LOCKHEED MARTIN ADVANCED ENERGY STORAGE,LLC, Bethesda, MD (US)

(72) Inventor: Adam MORRIS-COHEN, Maynard, MA (US)

(21) Appl. No.: 15/076,538

(22) Filed: Mar. 21, 2016

(51) Int. Cl. H01M 8/18; H01M 8/0289; H01M 8/0202; H01M 8/20

(52) U.S. Cl. CPC H01M 8/188; H01M 8/20; H01M 8/0289; H01M 8/0202

(57) ABSTRACT

Crossover of active materials in an electrochemical cell can detrimentally impact operating performance, particularly for flow batteries. Flow batteries with tolerance toward crossover of active materials can incorporate a first half-cell containing a first electrolyte solution that includes a coordination complex as a first active material, and a second half-cell containing a second electrolyte solution that includes an unbound form of an organic compound as a second active material. The coordination complex contains a redox-active metal center and an organic compound bound to the redox-active metal center. The unbound form of the organic compound in the second electrolyte solution is the same as the bound organic compound in the first electrolyte solution, or an oxidized or reduced variant thereof. Catechol and substituted catechols can be particularly desirable organic compounds for inclusion in the coordination complex and the second electrolyte solution.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD

The present disclosure generally relates to energy storage and, more specifically, to approaches for mitigating crossover in flow batteries and related electrochemical systems.

### BACKGROUND

Electrochemical energy storage systems, such as batteries, supercapacitors and the like, have been widely proposed for large-scale energy storage applications. Various battery designs, including flow batteries, have been considered for this purpose. Compared to other types of electrochemical energy storage systems, flow batteries can be advantageous, particularly for large-scale applications, due to their ability to decouple the parameters of power density and energy density from one another.

Flow batteries generally include negative and positive active materials in corresponding electrolyte solutions, which are flowed separately across opposing faces of a membrane or separator in an electrochemical cell containing negative and positive electrodes. The flow battery is charged or discharged through electrochemical reactions of the active materials that occur inside the two half-cells. As used herein, the terms “active material,” “electroactive material,” “redox-active material” or variants thereof will synonymously refer to materials that undergo a change in oxidation state during operation of a flow battery or like electrochemical energy storage system (i.e., during charging or discharging).

Metal-based active materials can often be desirable for use in flow batteries and other electrochemical energy storage systems. Although non-ligated metal ions (e.g., dissolved salts of a redox-active metal) can be used as an active material, it can often be more desirable to utilize coordination complexes for this purpose. As used herein, the terms “coordination complex, “coordination compound,” and “metal-ligand complex” will synonymously refer to a compound having at least one covalent or dative bond formed between a metal center and a donor ligand. The metal center can cycle between an oxidized form and a reduced form in an electrolyte solution, where the oxidized and reduced forms represent states of full charge or full discharge depending upon the particular half-cell in which the coordination complex is present. Transition metals and their coordination complexes can be particularly desirable active materials due to their favorable electrochemical properties.

Although flow batteries hold significant promise for large-scale energy storage applications, they have often been plagued by poorer than expected energy storage performance (e.g., round trip energy efficiency) and limited cycle life, among other factors. Certain factors leading to sub-optimal energy storage performance are discussed hereinafter. Despite significant investigational efforts, no commercially viable flow battery technologies have yet been developed.

One factor that can lead to diminished performance of flow batteries and other electrochemical energy storage systems is crossover of active materials from one half-cell to the other. Crossover can result from concentration differences between the electrolyte solutions in the two half-cells, thereby establishing a concentration gradient across the membrane or separator. Despite the presence of the membrane or separator, there exists a finite flux of the negative and positive active materials to the opposing electrolyte solution due to the concentration gradient. The rate of crossover can be dependent upon the nature of both the active materials and the membrane or separator (e.g., charge states, hydrodynamic radii, pore sizes, and the like). Crossover can lead to a loss of energy efficiency due to self-discharge of the electrolyte solutions.

In addition to diminished performance arising from self-discharge, crossover can also lead to temporary or permanent damage to the flow battery if degradation products form that are incompatible with the flow battery components. If the substance(s) crossing over the separator are incompatible with one or more substances in the other half-cell, damage can occur. Alternately, if the substance(s) crossing over the separator are incompatible at the operating potential of the other half-cell, damage can likewise occur. Crossover-related damage can similarly decrease the energy storage capacity of flow batteries through loss of the active material from the electrolyte solution.

One approach for mitigating crossover in flow batteries involves utilizing the same redox-active metal in both half-cells of a flow battery but in different oxidation states. Any redox-active metal that crosses over the membrane or separator to the opposing half-cell can simply be converted into the other oxidation state upon charging or discharging the flow battery. In a similar approach, a mixture of both active materials can be placed in the opposing half-cells, although this strategy results in inefficient use of a potentially expensive active material. The foregoing approaches are not feasible, however, when different active materials are used in the two half-cells of the flow battery or when one of the active materials is incompatible with the conditions present in the other half-cell. In the case of differing active materials, there is presently no ready mechanism for re-directing crossover active material back to its original electrolyte solution in the other half-cell. Since crossover can continue until the concentration gradient is relieved, crossover can become an ever-increasing issue the longer an electrolyte solution is used. Significant crossover can necessitate replacement or rebalancing of one or more of the electrolyte solutions to restore a flow battery to its desired operating condition. For some active materials, this can represent a significant expense and possible waste disposal issue.

In view of the foregoing, flow batteries and other electrochemical systems with improved tolerance toward crossover of active materials would be highly desirable in the art. The present disclosure satisfies the foregoing needs and provides related advantages as well.

### SUMMARY

In some embodiments, flow batteries of the present disclosure include a first half-cell containing a first electrolyte solution and a second half-cell containing a second electrolyte solution. The first electrolyte solution includes a coordination complex as a first active material. The coordination complex includes a redox-active metal center and an organic compound bound to the redox-active metal center. The second electrolyte solution includes an unbound form of the organic compound, or a corresponding oxidized or reduced variant thereof, as a second active material.

In other various embodiments, flow batteries of the present disclosure include a first half-cell containing a first electrolyte solution and a second half-cell containing a second electrolyte solution. The first half-cell is a negative half-cell, and the second half-cell is a positive half-cell. The first electrolyte solution includes a coordination complex as a first active material. The coordination complex includes a redox-active metal center and an organic compound chosen from catechol, a substituted catechol, or any combination thereof bound to the redox-active metal center. The second electrolyte solution includes an unbound form of the organic compound, or a corresponding quinone variant thereof, as a second active material.

In some embodiments, the present disclosure describes methods for mitigating crossover in a flow battery. The methods include: providing a first electrolyte solution containing a coordination complex as a first active material, providing a second electrolyte solution containing an unbound organic compound as a second active material, disposing the first electrolyte solution and the second electrolyte solution on opposing sides of a separator in a flow battery, and operating the flow battery. The coordination complex includes a redox-active metal center and an organic compound chosen from catechol, a substituted catechol, or any combination thereof bound to the redox-active metal center. The organic compound in the second electrolyte solution is an unbound form of catechol, the substituted catechol, or a corresponding quinone variant thereof. Operating the flow battery includes reducing the redox-active metal center of the coordination complex in the first electrolyte solution and oxidizing the catechol or substituted catechol in the second electrolyte solution to the corresponding quinone variant, or oxidizing the redox-active metal center of the coordination complex in the first electrolyte solution and reducing the corresponding quinone variant in the second electrolyte solution to catechol or the substituted catechol.

The foregoing has outlined rather broadly the features of the present disclosure in order that the detailed description that follows can be better understood. Additional features and advantages of the disclosure will be described hereinafter. These and other advantages and features will become more apparent from the following description.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIG. 1 shows a schematic of an illustrative flow battery containing a single electrochemical cell; and

FIG. 2 shows illustrative cyclic voltammograms of NaKTi(catecholate)₂(monosulfonated catecholate) and unbound monsulfonated catechol plotted in the same field.

### DETAILED DESCRIPTION

The present disclosure is directed, in part, to flow batteries having improved tolerance toward crossover of active materials. The present disclosure is also directed, in part, to methods for improving tolerance of active material crossover in flow batteries and related electrochemical systems.

The present disclosure may be understood more readily by reference to the following description taken in connection with the accompanying figures and examples, all of which form a part of this disclosure. It is to be understood that this disclosure is not limited to the specific products, methods, conditions or parameters described and/or shown herein. Further, the terminology used herein is for purposes of describing particular embodiments by way of example only and is not intended to be limiting unless otherwise specified. Similarly, unless specifically stated otherwise, any description herein directed to a composition is intended to refer to both solid and liquid versions of the composition, including solutions and electrolytes containing the composition, and electrochemical cells, flow batteries, and other energy storage systems containing such solutions and electrolytes. Further, it is to be recognized that where the disclosure herein describes an electrochemical cell, flow battery, or other energy storage system, it is to be appreciated that methods for operating the electrochemical cell, flow battery, or other energy storage system are also implicitly described.

It is also to be appreciated that certain features of the present disclosure may be described herein in the context of separate embodiments for clarity purposes, but may also be provided in combination with one another in a single embodiment. That is, unless obviously incompatible or specifically excluded, each individual embodiment is deemed to be combinable with any other embodiment(s) and the combination is considered to represent another distinct embodiment. Conversely, various features of the present disclosure that are described in the context of a single embodiment for brevity's sake may also be provided separately or in any sub-combination. Finally, while a particular embodiment may be described as part of a series of steps or part of a more general structure, each step or sub-structure may also be considered an independent embodiment in itself.

Unless stated otherwise, it is to be understood that each individual element in a list and every combination of individual elements in that list is to be interpreted as a distinct embodiment. For example, a list of embodiments presented as “A, B, or C” is to be interpreted as including the embodiments “A,” “B,” “C,” “A or B,” “A or C,” “B or C,” or “A, B, or C.”

In the present disclosure, the singular forms of the articles “a,” “an,” and “the” also include the corresponding plural references, and reference to a particular numerical value includes at least that particular value, unless the context clearly indicates otherwise. Thus, for example, reference to “a material” is a reference to at least one of such materials and equivalents thereof.

In general, use of the term “about” indicates approximations that can vary depending on the desired properties sought to be obtained by the disclosed subject matter and is to be interpreted in a context-dependent manner based on functionality. Accordingly, one having ordinary skill in the art will be able to interpret a degree of variance on a case-by-case basis. In some instances, the number of significant figures used when expressing a particular value may be a representative technique of determining the variance permitted by the term “about.” In other cases, the gradations in a series of values may be used to determine the range of variance permitted by the term “about.” Further, all ranges in the present disclosure are inclusive and combinable, and references to values stated in ranges include every value within that range.

As discussed above, energy storage systems that are operable on a large scale while maintaining high efficiency values can be extremely desirable. Flow batteries have generated significant interest in this regard, but there remains considerable room for improving their operating characteristics. Crossover of active materials between the two half-cells of a flow battery is one factor that can undesirably impact various operating characteristics. In conventional flow battery designs having differing active materials in the two half-cells, crossover can be especially difficult to manage, and there may be no choice but to replenish one or both electrolyte solutions once a threshold amount of crossover has been reached.

As further indicated above, metal-based active materials can be desirable for use in flow batteries and related electrochemical systems, particularly transition metals and/or their coordination complexes. Coordination complexes of transition metals can be particularly desirable due to their tunable solubility performance and favorable electrochemical parameters. In many instances, however, different coordination complexes, oftentimes also having differing metal centers, are utilized in the two half-cells of flow batteries. The resulting concentration gradient between the two half-cells then leads to a propensity toward crossover.

For most coordination complexes used in conventional flow batteries, the electrochemical reactions taking place in the electrolyte solutions are metal-based and do not involve the ligands complexed to the metal center. That is, the ligands are spectators to the oxidation-reduction process and do not undergo a change in their oxidation state. For purposes of this disclosure, ligands that lack redox activity under the operating conditions of a flow battery will be considered to be “innocent.” Hence, during operation of a flow battery, the metal center can cycle between an oxidized form and a reduced form, where the oxidized and reduced forms of the metal center represent states of full charge or full discharge depending upon the particular half-cell in which the coordination complex is present. In many instances, the oxidation-reduction cycle of transition metals in flow batteries involves a change in oxidation state of +1 or −1 at the metal center.

Some ligands are also potentially capable of undergoing a reversible oxidation-reduction cycle. For purposes of this disclosure, such ligands will be referred to as being “redox non-innocent.” Ligand-based oxidation state changes of an active material can sometimes be undesirable, since complicated and occasionally unpredictable electrochemical behavior of the coordination complex can result. In addition, the chemical stability of a coordination complex can be altered upon changing the oxidation state of a ligand. Specifically, the oxidized or reduced form of the ligand can be less effective at forming a dative bond with a given metal center. Some ligands that are potentially subject to redox non-innocent behavior in their free (unbound) form are stabilized toward oxidation state changes when bound to a metal center. In other instances, ligand-based oxidation state changes can be desired, and are also encompassed within the realm of the present disclosure.

Catechol and substituted catechols represent one class of ligands that are reasonably stable toward oxidation when bound to a metal center but are prone toward oxidation into the corresponding quinone when not, particularly under basic conditions and positive potentials. As used herein, the term “catechol” will refer to a compound having an aromatic ring bearing hydroxyl groups on adjacent carbon atoms (i.e., 1,2-hydroxyl groups). Optional substitution can also be present in addition to the 1,2-hydroxyl groups. The term “catecholate” may be used herein to refer to a substituted or unsubstituted catechol compound that is bound to a metal center via a metal-ligand bond. Coordination complexes containing at least one catechol or substituted catechol bound to a metal center as a ligand can be particularly desirable active materials for use in flow batteries and other electrochemical systems due to their favorable electrochemical kinetics and reversible electrochemical behavior. In addition, such coordination complexes can be favorable due to their reasonably high aqueous solubility values and the minimal cost of catechol (i.e., 1,2-dihydroxybenzene) itself.

Transition metal complexes containing catechol and/or substituted catechols as ligands can be particularly desirable active materials for use in conventional flow batteries and other electrochemical systems, especially when incorporated in the negative half-cell. Titanium can be a particularly desirable transition metal in this regard. In the positive half-cell, iron hexacyanide complexes can provide good electrochemical performance, particularly when paired with a titanium coordination complex in the negative half-cell. Other pairings of differing coordination complexes in the two half-cells can also be suitable in this regard. Although flow batteries having differing active materials present in the two half-cells can offer good electrochemical performance, such as a catechol complex in the negative half-cell and a coordination complex not containing a catechol in the positive half-cell, such flow batteries can be prone toward crossover, as discussed above.

Flow batteries containing organic-based active materials within both half-cells are also known. Organic-based active materials function through oxidation state changes that occur within an organic compound itself rather than at a metal center. In fact, organic-based active materials are usually not complexed to a metal center at all, particularly not a redox-active metal center. Organic-based active materials can oftentimes transfer multiple electrons during an oxidation-reduction cycle, in contrast to the one-electron transfer processes that are common with metal-based active materials. Advantages of including organic-based active materials in both half-cells of a flow battery can therefore include eliminating metal sourcing costs and increasing the number of electrons transferred per oxidation-reduction cycle. Like coordination complexes, crossover of organic-based active materials can occur when differing organic-based active materials are present in the two half-cells.

In contrast to conventional flow battery configurations, in which both half-cells contain a coordination complex or an organic-based active material, the present inventor discovered that loading the two half-cells with differing classes of active materials could provide a number of advantages. Specifically, the inventor discovered that by loading one half-cell with a coordination complex as an active material and loading the other half-cell with an organic-based active material of suitable complementarity, significantly increased tolerance toward crossover can be realized. More specifically, the inventor recognized that significantly improved tolerance toward crossover can be realized by incorporating a potentially redox-active ligand in a coordination complex in a first half-cell, and utilizing an unbound form of the ligand, or a corresponding oxidized or reduced variant thereof, as the active material in a second half-cell. If desired, the ligand can be chosen such that it is substantially stable toward oxidation and reduction when bound to the metal center, such that it does not complicate the electrochemical performance in the first half cell. In other instances, the ligand can be chosen to have oxidation-reduction activity even in its bound form, thereby allowing the coordination complex in which it is present to transfer multiple electrons in a single oxidation-reduction cycle. That is, redox non-innocent ligands can also be suitably used in the embodiments of the present disclosure. Further description and advantages concerning the foregoing will be described hereinafter for the specific case of a coordination complex containing catechol and/or a substituted catechol as a first active material and an unbound form of the catechol and/or substituted catechol, or a corresponding quinone variant thereof, serving as a second active material. With the benefit of the present disclosure, one having ordinary skill in the art can envision other suitable pairings.

As indicated above, catechols have substantial stability toward oxidation to the corresponding quinone when bound to a metal center in a coordination complex. Coordination complexes containing catechols, in turn, can display stability toward disassociation when the complex is maintained at slightly alkaline to strongly alkaline pH values and negative potentials, thereby keeping the catechols deprotonated and bound to the metal center. Negative potentials also are not prone to promote catechol oxidation. In contrast, coordination complexes containing catechols can readily degrade or disassociate upon exposure to positive potentials, particularly at alkaline pH values. Accordingly, in flow batteries containing a coordination complex with catechols bound to a metal center, the electrolyte solution containing the coordination complex is typically maintained in the negative half-cell at an alkaline pH value (i.e., about 7 to about 14). Because a different coordination complex is utilized in the positive half-cell in such flow batteries, they can be prone to active material crossover, as discussed in more detail above.

Upon undergoing crossover and being exposed to a positive potential, coordination complexes containing catechols can undergo disassociation to form an unbound form of the catechol compounds and an unbound metal ion. In an electrolyte solution containing another coordination complex, the unbound catechol compounds and/or the unbound metal ion can introduce a number of issues. In some cases, the unbound catechol compounds and/or the unbound metal ion can undergo competing electrochemical reactions with the desired positive active material. In addition, if the positive electrolyte solution is sufficiently alkaline, the unbound catechol compounds can undergo irreversible degradation to form sludge or other degradation products that can compromise the operability of the positive electrolyte solution or the various components of the flow battery as a whole. At acidic pH values, free catechol compounds are considerably more stable toward degradation and still maintain high solubility values. Hence, it can be desirable to maintain the positive electrolyte solution at acidic pH values to circumvent possible damage from degradation of catechol compounds, although such pH values can be inconvenient or even incompatible for use with some active materials. For example, although iron hexacyanide complexes can be desirable active materials for inclusion in the positive electrolyte solution of flow batteries and other electrochemical systems, they can be susceptible toward degradation of the cyanide ligands if the pH is too low and also demonstrate poor solubility at acidic pH values. Hence, it can be especially difficult to manage crossover in conventional flow batteries in which coordination complexes containing catechols are present.

As discussed hereinafter, the present inventor recognized that significantly improved crossover tolerance could be realized through utilizing an electrolyte solution in the positive half-cell containing an unbound and redox-active form of the same catechol or substituted catechol that is present in a coordination complex within the negative half-cell. Crossover tolerance in both directions (i.e., from the negative half-cell to the positive half-cell, or vice versa) can be realized, particularly by appropriately balancing the pH of the electrolyte solutions to promote degradation or stability of the coordination complex and/or the unbound catechols as appropriate. In the case of crossover of the coordination complex to the positive half-cell, the coordination complex can degrade or disassociate following crossover to form unbound catechols that simply increase the concentration of the active material already present in the positive half-cell. Since it can be desirable to maintain the positive electrolyte solution at an acidic pH to stabilize the unbound catechol(s) serving as the positive active material, any catechols disassociating from the metal center can be similarly stabilized. Intermediate pH values at which both the coordination complex and the unbound catechol are stable can also be used. In the case of crossover of the unbound catechols to the negative half-cell, the unbound catechols can encounter pH conditions upon crossing the membrane or separator where the catechols are again active to complex any unbound metal ions that may be present. Therefore, the pH of the electrolyte solution in the negative half-cell can be adjusted such that it is sufficiently alkaline to maintain stability and/or formation of the coordination complex but not too alkaline to promote degradation of unbound catechols. Since oxidation of catechols is not a facile process under negative potentials, degradation of any catechol that crosses over into negative half-cell is not generally a concern. Hence, crossover of the active materials in either direction can produce a lower impact on the operating performance of flow batteries than in conventional configurations in which active materials of similar class are present in both half-cells.

In addition to improved crossover tolerance, flow batteries incorporating unbound catechols as an active material can provide further advantages as well. In particular, unbound catechols in the positive half-cell can carry multiple electrons over a single oxidation-reduction cycle. Specifically, the reversible interconversion of catechols to their corresponding quinones is a two-electron process. Catechol compounds bearing other redox non-innocent functional groups can be similarly beneficial in this regard. The ability of catechols to transfer multiple electrons during an oxidation-reduction cycle can allow decreased quantities of active materials and/or lower concentration electrolyte solutions to be used. Lower concentration electrolyte solutions can be particularly desirable to limit the risk of active material precipitation occurring during the operation of a flow battery. Table 1 below summarizes some considerations of using catechol as an active material in the positive half-cell of a flow battery in comparison to an iron hexacyanide complex.

TABLE 1

| | | | | | | Electron |
|---|---|---|---|---|---|---|
| | Formula | | | | Aqueous | Aqueous |
| | Weight | Cost | Cost | Cost | Solubility | Solubility |
| | (g/mol) | ($/kg) | ($/mol) | ($/electron) | (M) | (M) |
| Fe(CN)₆³⁻^{/4-} | 396 | 2.11 | 0.836 | 0.836 | 1.3-1.6 | 1.3-1.6 |
| Catechol | 110 | 3.95 | 0.434 | 0.217 | 3.9 | 7.8 |

Although catechol has a higher cost on a per kilogram basis, this compound offers a much lower cost on a molar basis. In addition, due to its higher solubility and ability to transfer multiple electrons, catechol offers a much higher effective concentration of transferrable electrons in an electrolyte solution.

Before discussing the various embodiments of the present disclosure, in which a coordination complex containing a potentially redox-active organic compound is used as a first active material and an unbound form of the organic compound is used as a second active material, a brief discussion of flow batteries and their operating characteristics will be provided first.

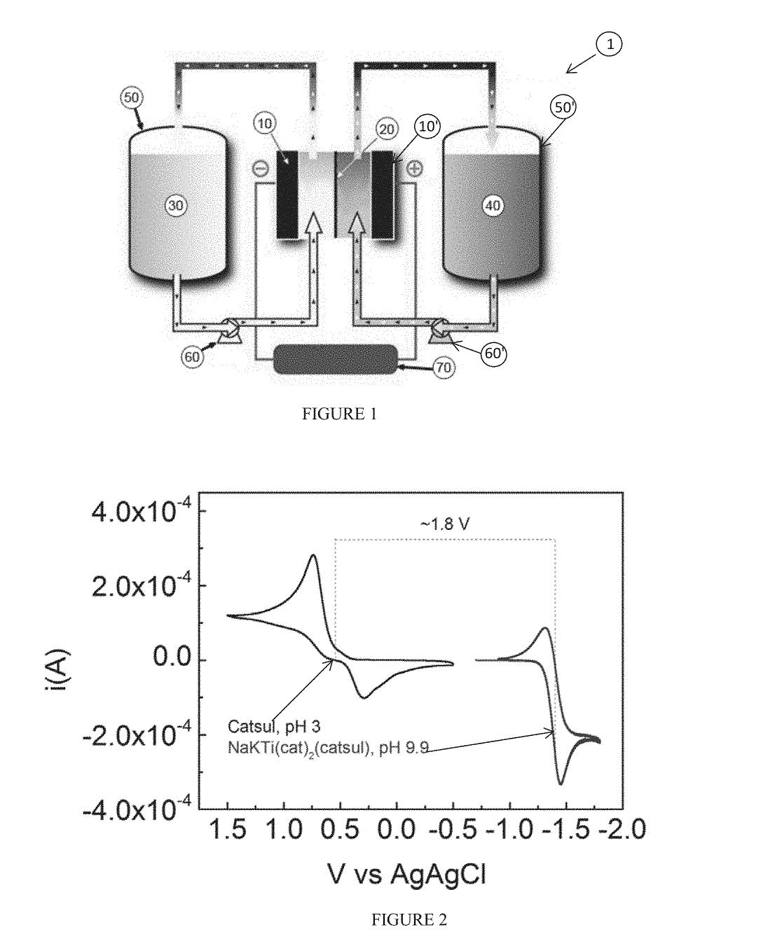

Unlike typical battery technologies (e.g., Li-ion, Ni-metal hydride, lead-acid, and the like), where active materials and other components are housed in a single assembly, flow batteries transport (e.g., via pumping) redox-active energy storage materials from storage tanks through an electrochemical stack containing one or more electrochemical cells. This design feature decouples the electrical energy storage system power from the energy storage capacity, thereby allowing for considerable design flexibility and cost optimization. FIG. 1 shows a schematic of an illustrative flow battery containing a single electrochemical cell. Although FIG. 1 shows a flow battery containing a single electrochemical cell, approaches for combining multiple electrochemical cells together are known and are discussed hereinbelow. Hence, the configuration of FIG. 1 should not be considered limiting.

As shown in FIG. 1, flow battery system 1 includes an electrochemical cell that features separator 20 between the two electrodes 10 and 10′ of the electrochemical cell. As used herein, the terms “separator” and “membrane” will refer to an ionically conductive and electrically insulating material disposed between the positive and negative electrodes of an electrochemical cell. Electrodes 10 and 10′ are formed from a suitably conductive material, such as a metal, carbon, graphite, and the like, and the materials for the two can be the same or different, Although FIG. 1 has shown electrodes 10 and 10′ as being spaced apart from separator 20, electrodes 10 and 10′ can also be disposed in contact with separator 20 in more particular embodiments. The material(s) forming electrodes 10 and 10′ can be porous, such that they have a high surface area for contacting the electrolyte solutions containing first active material 30 and second active material 40, which are capable of being cycled between an oxidized state and a reduced state.

Pump 60 affects transport of first active material 30 from tank 50 to the electrochemical cell. The flow battery also suitably includes second tank 50′ that contains second active material 40. Second active material 40 can be the same material as first active material 30, or it can be different. Second pump 60′ can affect transport of second active material 40 to the electrochemical cell. Pumps can also be used to affect transport of active materials 30 and 40 from the electrochemical cell back to tanks 50 and 50′ (not shown in FIG. 1). Other methods of affecting fluid transport, such as siphons, for example, can also suitably transport first and second active materials 30 and 40 into and out of the electrochemical cell. Also shown in FIG. 1 is powersource or load 70, which completes the circuit of the electrochemical cell and allows a user to collect or store electricity during its operation.

It should be understood that FIG. 1 depicts a specific, non-limiting configuration of a particular flow battery. Accordingly, flow batteries consistent with the spirit of the present disclosure can differ in various aspects relative to the configuration of FIG. 1. As one example, a flow battery system can include one or more active materials that are solids, gases, and/or gases dissolved in liquids. Active materials can be stored in a tank, in a vessel open to the atmosphere, or simply vented to the atmosphere.

Various embodiments of flow batteries configured in accordance with the present disclosure will now be described in further detail. In various embodiments, flow batteries of the present disclosure can contain a first half-cell containing a first electrolyte solution, and a second half-cell containing a second electrolyte solution. The first electrolyte solution contains a coordination complex as a first active material, where the coordination complex contains a redox-active metal center and an organic compound bound to the redox-active metal center (i.e., as a ligand). The second electrolyte solution contains an unbound form of the organic compound, or an oxidized or reduced form thereof, as a second active material. That is, the unbound form of the organic compound in the second electrolyte solution is the same as that in the first electrolyte solution, except that the organic compound is not bound to a metal center in the second electrolyte solution. In some embodiments, the organic compound can lack redox activity when bound to the redox-active metal center. In other embodiments, the organic compound can also contain a redox non-innocent functional group.

In some embodiments, the redox-active metal center of the coordination complex can be a transition metal. Due to their variable oxidation states, transition metals can be highly desirable for use as at least one of the active materials in a flow battery. Cycling between the accessible oxidation states can result in the conversion of chemical energy into electrical energy. Lanthanide metals can be used similarly in this regard in alternative embodiments. In general, any transition metal or lanthanide metal can be present as the redox-active metal center in the coordination complexes used in the flow batteries described herein. In more specific embodiments, the redox-active metal center can be a transition metal selected from among Al, Cr, Ti and Fe. For purposes of the present disclosure, Al is to be considered a transition metal. In more specific embodiments, the transition metal can be Ti. Other suitable transition and main group metals that can be present in the coordination complexes include, for example, Ca, Ce, Co, Cu, Mg, Mn, Mo, Ni, Pd, Pt, Ru, Sr, Sn, V, Zn, Zr, and any combination thereof. In various embodiments, the coordination complex can include a transition metal in a non-zero oxidation state when the transition metal is in both its oxidized and reduced forms. Cr, Fe, Mn, Ti and V can be particularly desirable in this regard.

In more specific embodiments, the coordination complex can have a formula of

D_{g}M(L₁)(L₂)(L₃),

where M is a transition metal; D is a counterion selected from H⁺, NH₄⁺, tetraalkylammonium (C₁-C₄ alkyl), an alkali metal ion (e.g., Li⁺, Na⁺ or K⁺), or any combination thereof; g ranges between 0 and about 8; and L₁, L₂ and L₃ are ligands, provided that at least one of L₁, L₂ and L₃ is redox-active in its unbound form. In some embodiments, D can be chosen from among Li⁺, Na⁺, K⁺, or any combination thereof, and in some more specific embodiments, D can be a mixture of Na⁺ and K⁺ counterions. In other more specific embodiments, the coordination complex can include titanium as the redox-active metal center, as discussed above.

In addition to the foregoing coordination complexes bearing three ligands, coordination complexes containing even greater numbers of ligands are possible. For example, coordination complexes can contain, four, five, six, seven or eight ligands, any of which can be monodentate, bidentate or tridentate, provided that at least one of the ligands is redox-active in its unbound form. Further examples of suitable ligands are discussed hereinafter.

In still more specific embodiments, the organic compound present in the first electrolyte solution within the coordination complex and in the second electrolyte solution in an unbound form can be catechol, a substituted catechol, or any combination thereof. As discussed in more detail above, catechol and substituted catechols can be particularly desirable in the embodiments of the present disclosure due to their ready complexation of metal ions and their relative stability toward degradation and oxidation while complexed thereto, and their facile oxidation to produce the corresponding quinone when not complexed to a metal center.

In more particular embodiments, the organic compound can include at least a monosulfonated catechol, such as 3,4-dihydroxybenzenesulfonic acid or a salt thereof, for example. Monosulfonated catechols can be particularly desirable due to their ability to promote solubility of coordination complexes without detrimentally impacting the complexes' electrochemical properties.

In some or other more specific embodiments, D can be chosen from among NH₄⁺, Li⁺, Na⁺, K⁺, or any combination thereof g can range between 2 and 6, and at least one of L₁, L₂ and L₃ can be catechol, a substituted catechol, or a salt thereof.

In some embodiments of the present disclosure, at least one of L₁, L₂ and L₃ is catechol or a substituted catechol. In some embodiments, each of L₁, L₂ and L₃ is catechol or a substituted catechol. In other embodiments, one of L₁, L₂ and L₃ is catechol or a substituted catechol, and two of L₁, L₂ and L₃ are not a catechol compound or a salt thereof. In still other embodiments, two of L₁, L₂ and L₃ are catechol or a substituted catechol, and one of L₁, L₂ and L₃ is not a catechol compound or a salt thereof. In the foregoing embodiments, at least one of L₁, L₂ and L₃ can be a substituted catechol, and in still more specific embodiments, at least one of L₁, L₂ and L₃ can be a monosulfonated catechol.

As indicated above, titanium coordination complexes containing catechol or a substituted catechol as a ligand can be particularly desirable coordination complexes for use as an active material within the first electrolyte solution of a flow battery. Accordingly, in still more specific embodiments of the present disclosure, the coordination complex present within the first electrolyte solution can have a formula of

D_{g}Ti(L₁)(L₂)(L₃),

where D is a counterion selected from H⁺, NH₄⁺, Li⁺, Na⁺, K⁺, or any combination thereof; g ranges between 2 and 6; and L₁, L₂ and L₃ are ligands and at least one of L₁, L₂ and L₃ is catechol or a substituted catechol. In some embodiments, D can be chosen from among Li⁺, Na⁺, K⁺, or any combination thereof, and in some more specific embodiments, D can be a mixture of Na⁺ and K⁺ counterions.

In some embodiments, ligands other than catechol or a substituted catechol can be present in the coordination complex within the first electrolyte solution. Other ligands that can be present in the coordination complexes include, for example, ascorbate, citrate, glycolate, a polyol, gluconate, hydroxyalkanoate, acetate, formate, benzoate, malate, maleate, phthalate, sarcosinate, salicylate, oxalate, urea, polyamine, aminophenolate, acetylacetonate, and lactate. Where chemically feasible, it is to be recognized that such ligands can be optionally substituted with at least one group selected from among C₁₋₆ alkoxy, C₁₋₆ alkyl, C₁₋₆ alkenyl, C₁₋₆ alkynyl, 5- or 6-membered aryl or heteroaryl groups, a boronic acid or a derivative thereof, a carboxylic acid or a derivative thereof, cyano, halide, hydroxyl, nitro, sulfonate, a sulfonic acid or a derivative thereof, a phosphonate, a phosphonic acid or a derivative thereof, or a glycol, such as polyethylene glycol. Alkanoate includes any of the alpha, beta, and gamma forms of these ligands. Polyamines include, but are not limited to, ethylenediamine, ethylenediamine tetraacetic acid (EDTA), and diethylenetriamine pentaacetic acid (DTPA).

Still other examples of ligands that can be present in the coordination complexes in combination with catechol, a substituted catechol, and/or any of the other aforementioned ligands can include monodentate, bidentate, and/or tridentate ligands. Examples of monodentate ligands that can be present in the coordination complexes include, for example, carbonyl or carbon monoxide, nitride, oxo, hydroxo, water, sulfide, thiols, pyridine, pyrazine, and the like. Examples of bidentate ligands that can be present in the coordination complexes include, for example, bipyridine, bipyrazine, ethylenediamine, diols (including ethylene glycol), and the like. Examples of tridentate ligands that can be present in the coordination complexes include, for example, terpyridine, diethylenetriamine, triazacyclononane, tris(hydroxymethyl)aminomethane, and the like.

In still more specific embodiments, the first half-cell, in which the coordination complex is present in the first electrolyte solution, can be a negative half-cell of the flow battery, and the second half-cell, in which the unbound form of the organic compound is present in the second electrolyte solution, can be a positive half-cell of the flow battery. In the case of the organic compound being catechol or a substituted catechol, the disposition of coordination complex in the negative half-cell and the unbound catechol or substituted catechol in the positive half-cell can be particularly beneficial, as discussed in more detail above. More specifically, in some embodiments, the positive half-cell can be operable at a potential which promotes disassociation of the coordination complex upon crossover, such as occurs in the case of coordination complexes containing catechol or substituted catechols as ligands.

In some or other embodiments, the second electrolyte solution can have a pH at which the coordination complex degrades or disassociates to form the unbound form of the organic compound, or the oxidized or reduced variant thereof. For example, in the case of coordination complexes containing catechol or a substituted catechol, the second electrolyte solution can have an acidic pH, which can promote disassociation of the catechol ligands. Particularly suitable pH ranges for the first and second electrolyte solutions in the case of the organic compound being catechol or a substituted catechol are discussed in further detail hereinbelow. Again, it is to be recognized that redox-active organic compounds other than catechol or substituted catechols can also be used without departing from the scope of the present disclosure. In the case of other redox-active organic compounds, one having ordinary skill in the art can determine appropriate pH ranges for the first and second electrolyte solutions to promote stabilization or degradation of a coordination complex or an unbound form of an organic compound as needed.

Accordingly, in more specific embodiments, flow batteries of the present disclosure can include a first half-cell containing a first electrolyte solution and a second half-cell containing a second electrolyte solution. The first half-cell is a negative half-cell and the second half-cell is a positive half-cell. The first electrolyte solution contains a coordination complex as a first active material, where the coordination complex contains a redox-active metal center and an organic compound including catechol, a substituted catechol, or any combination thereof bound to the redox-active metal center. The second electrolyte solution contains an unbound form of the organic compound, or a corresponding quinone variant thereof, as a second active material. The unbound organic compound in the second electrolyte solution is the same as that in the first electrolyte solution, or a quinone variant thereof, but the organic compound is not bound to a metal center in the second electrolyte solution.

In some embodiments, the electrolyte solutions used in the flow batteries of the present disclosure can be an aqueous electrolyte solution in which the corresponding active materials are dissolved. As used herein, the term “aqueous solution” will refer to a homogeneous liquid phase with water as a predominant solvent in which an active material is at least partially solubilized, ideally fully solubilized. This definition encompasses both solutions in water and solutions containing a water-miscible organic solvent as a minority component of an aqueous phase.

Illustrative water-miscible organic solvents that can be present in an aqueous electrolyte solution include, for example, alcohols and glycols, optionally in the presence of one or more surfactants or other components discussed below. In more specific embodiments, an aqueous electrolyte solution can contain at least about 98% water by weight. In other more specific embodiments, an aqueous electrolyte solution can contain at least about 55% water by weight, or at least about 60% water by weight, or at least about 65% water by weight, or at least about 70% water by weight, or at least about 75% water by weight, or at least about 80% water by weight, or at least about 85% water by weight, or at least about 90% water by weight, or at least about 95% water by weight. In some embodiments, an aqueous electrolyte solution can be free of water-miscible organic solvents and consist of water alone as a solvent.

In further embodiments, an aqueous electrolyte solution can include a viscosity modifier, a wetting agent, or any combination thereof. Suitable viscosity modifiers can include, for example, corn starch, corn syrup, gelatin, glycerol, guar gum, pectin, and the like. Other suitable examples will be familiar to one having ordinary skill in the art. Suitable wetting agents can include, for example, various non-ionic surfactants and/or detergents. In some or other embodiments, an aqueous electrolyte solution can further include a glycol or a polyol. Suitable glycols can include, for example, ethylene glycol, diethylene glycol, and polyethylene glycol. Suitable polyols can include, for example, glycerol, mannitol, sorbitol, pentaerythritol, and tris(hydroxymethyl)aminomethane. Inclusion of any of these components in an aqueous electrolyte solution can help promote dissolution of a coordination complex or similar active material and/or reduce viscosity of the aqueous electrolyte solution for conveyance through a flow battery, for example.

In addition to a solvent and a coordination complex as an active material, an aqueous electrolyte solution can also include one or more mobile ions (i.e., an extraneous electrolyte). In some embodiments, suitable mobile ions can include proton, hydronium, or hydroxide. In other various embodiments, mobile ions other than proton, hydronium, or hydroxide can be present, either alone or in combination with proton, hydronium or hydroxide. Such alternative mobile ions can include, for example, alkali metal or alkaline earth metal cations e.g., Li⁺, Na⁺, K⁺, Mg²⁺, Ca²⁺ and Sr²⁺) and halides (e.g., F⁻, Cl⁻, or Br⁻). Other suitable mobile ions can include, for example, ammonium and tetraalkylammonium ions, chalcogenides, phosphate, hydrogen phosphate, phosphonate, nitrate, sulfate, nitrite, sulfite, perchlorate, tetrafluoroborate, hexafluorophosphate, and any combination thereof. In some embodiments, less than about 50% of the mobile ions can constitute protons, hydronium, or hydroxide. In other various embodiments, less than about 40%, less than about 30%, less than about 20%, less than about 10%, less than about 5%, or less than about 2% of the mobile ions can constitute protons, hydronium, or hydroxide.

In more specific embodiments, the first electrolyte solution, which contains the coordination complex having catechol or a substituted catechol as a ligand, can be maintained at an alkaline pH value, and the second electrolyte solution, which contains the unbound form of catechol or the substituted catechol, or the corresponding quinone variant thereof, can be maintained at an acidic pH. As discussed in more detail above, an acidic pH in the second electrolyte solution can desirably promote disassociation of any coordination complex that crosses over the membrane of the flow battery into the positive half-cell. More specific disclosure in regard to the pH values of the first and second electrolyte solutions follows hereinafter.

As used herein, the term “alkaline pH” will refer to any pH value between about 7 and about 14. In some embodiments, one or more buffers can be present in the first electrolyte solution in which the coordination complex containing catechol or a substituted catechol is present to help maintain the pH at an alkaline value. In more specific embodiments, the first electrolyte solution can be maintained at a pH of about 9 to about 12. Such pH values can promote stability of coordination complexes containing catechol or substituted catechols as ligands and lessen the likelihood of crossover. At alkaline pH values ranging between about 7 and about 9, the coordination complexes can still remain stable, but the likelihood of crossover can be increased. For example, some ligand disassociation can occur at lower pH values, and the disassociated ligands can be more prone toward crossover than is the parent coordination complex. Accordingly, other illustrative alkaline pH ranges that can be maintained in the first electrolyte solution include, for example, about 7 to about 7.5, or about 7.5 to about 8, or about 8 to about 8.5, or about 8.5 to about 9, or about 9.5 to about 10, or about 10 to about 10.5, or about 10.5 to about 11, or about 11 to about 11.5, or about 11.5 to about 12, or about 12 to about 12.5, or about 12.5 to about 13, or about 13 to about 13.5, or about 13.5 to about 14. Illustrative buffers that can be present include, but are not limited to, salts of phosphates, borates, carbonates, silicates, tris(hydroxymethyl)aminomethane (TRIS), 4-(2-hydroxyethyl)-1-piperazineethanesulfonic acid (HEPES), piperazine-N,N′-bis(ethanesulfonic acid) (PIPES), or any combination thereof.

As used herein, the term “acidic pH” will refer to any pH value between about 0 and about 7. In some embodiments, one or more buffers can be present in the second electrolyte solution in which the unbound catechol or substituted catechol is present to help maintain the pH at an acidic value. In more specific embodiments, the second electrolyte solution can be maintained at a pH of about 4 to about 7, or between about 3 and about 6, or between about 4.5 and about 6.5. Such pH values can be sufficiently acidic to promote stabilization of unbound catechol or substituted catechols while also promoting degradation of coordination complexes containing these ligands. As indicated above, intermediate pH values of about 7 to about 9 can also be suitably used with catecholate coordination complexes and catechol itself.

In some embodiments, the first electrolyte solution can have a concentration of the coordination complex, specifically a coordination complex containing catechol or a substituted catechol as ligands, at a concentration ranging between 0.1 M and about 3 M. This concentration range represents the sum of the individual concentrations of the oxidized and reduced forms of the coordination complex. In more particular embodiments, the concentration of the coordination complex can range between about 0.5 M and about 3 M, or between 1 M and about 3 M, or between about 1.5 M and about 3 M, or between 1 M and about 2.5 M. In some or other embodiments, the second electrolyte solution can have a concentration of unbound catechol or substituted catechol, or the corresponding quinone variant thereof, ranging between about 1 M and about 5 M. In more particular embodiments, the second electrolyte solution can have a concentration of unbound catechol or substituted catechol, or the corresponding quinone variant thereof, ranging between about 2 M and about 4 M, or between about 1 M and about 4 M, or between about 1.5 M and about 4.5 M.

Flow batteries of the present disclosure can provide sustained charge or discharge cycles of several hour durations. As such, they can be used to smooth energy supply/demand profiles and provide a mechanism for stabilizing intermittent power generation assets (e.g., from renewable energy sources such as solar and wind energy). It should be appreciated, then, that various embodiments of the present disclosure include energy storage applications where such long charge or discharge durations are desirable. For example, in non-limiting examples, the flow batteries of the present disclosure can be connected to an electrical grid to allow renewables integration, peak load shifting, grid firming, baseload power generation and consumption, energy arbitrage, transmission and distribution asset deferral, weak grid support, frequency regulation, or any combination thereof. When not connected to an electrical grid, the flow batteries of the present disclosure can be used as power sources for remote camps, forward operating bases, off-grid telecommunications, remote sensors, the like, and any combination thereof. Further, while the disclosure herein is generally directed to flow batteries, it is to be appreciated that other electrochemical energy storage media can incorporate the electrolyte solutions and coordination complexes described herein, specifically those utilizing stationary electrolyte solutions.

In some embodiments, flow batteries can include: a first chamber containing a negative electrode contacting a first aqueous electrolyte solution; a second chamber containing a positive electrode contacting a second aqueous electrolyte solution, and a separator disposed between the first and second electrolyte solutions. The chambers provide separate reservoirs within the cell, through which the first and/or second electrolyte solutions circulate so as to contact the respective electrodes and the separator. Each chamber and its associated electrode and electrolyte solution define a corresponding half-cell. The separator provides several functions which include, for example, (1) serving as a barrier to mixing of the first and second electrolyte solutions, (2) electrically insulating to reduce or prevent short circuits between the positive and negative electrodes, and (3) to facilitate ion transport between the positive and negative electrolyte chambers, thereby balancing electron transport during charge and discharge cycles. The negative and positive electrodes provide a surface where electrochemical reactions can take place during charge and discharge cycles. During a charge or discharge cycle, electrolyte solutions can be transported from separate storage tanks through the corresponding chambers, as shown in FIG. 1. In a charging cycle, electrical power can be applied to the cell such that the active material contained in the second electrolyte solution undergoes a one or more electron oxidation and the active material in the first electrolyte solution undergoes a one or more electron reduction. Similarly, in a discharge cycle the second active material is reduced and the first active material is oxidized to generate electrical power.

The separator can be a porous membrane in some embodiments and/or an ionomer membrane in other various embodiments. In some embodiments, the separator can be formed from an ionically conductive polymer.

Polymer membranes can be anion- or cation-conducting electrolytes. Where described as an “ionomer,” the term refers to polymer membrane containing both electrically neutral repeating units and ionized repeating units, where the ionized repeating units are pendant and covalently bonded to the polymer backbone. In general, the fraction of ionized units can range from about 1 mole percent to about 90 mole percent. For example, in some embodiments, the content of ionized units is less than about 15 mole percent; and in other embodiments, the ionic content is higher, such as greater than about 80 mole percent. In still other embodiments, the ionic content is defined by an intermediate range, for example, in a range of about 15 to about 80 mole percent. Ionized repeating units in an ionomer can include anionic functional groups such as sulfonate, carboxylate, and the like. These functional groups can be charge balanced by, mono-, di-, or higher-valent cations, such as alkali or alkaline earth metals. Ionomers can also include polymer compositions containing attached or embedded quaternary ammonium, sulfonium, phosphazenium, and guanidinium residues or salts. Suitable examples will be familiar to one having ordinary skill in the art.

In some embodiments, polymers useful as a separator can include highly fluorinated or perfluorinated polymer backbones. Certain polymers useful in the present disclosure can include copolymers of tetrafluoroethylene and one or more fluorinated, acid-functional co-monomers, which are commercially available as NAFION™ perfluorinated polymer electrolytes from DuPont. Other useful perfluorinated polymers can include copolymers of tetrafluoroethylene and FSO₂—CF₂CF₂CF₂CF₂—O—CF═CF₂, FLEMION™ and SELEMION™.

Additionally, substantially non-fluorinated membranes that are modified with sulfonic acid groups (or cation exchanged sulfonate groups) can also be used. Such membranes can include those with substantially aromatic backbones such as, for example, polystyrene, polyphenylene, biphenyl sulfone (BPSH), or thermoplastics such as polyetherketones and polyethersulfones.

Battery-separator style porous membranes, can also be used as the separator. Because they contain no inherent ionic conduction capabilities, such membranes are typically impregnated with additives in order to function. These membranes typically contain a mixture of a polymer and inorganic filler, and open porosity. Suitable polymers can include, for example, high density polyethylene, polypropylene, polyvinylidene difluoride (PVDF), or polytetrafluoroethylene (PTFE). Suitable inorganic fillers can include silicon carbide matrix material, titanium dioxide, silicon dioxide, zinc phosphide, and ceria.

Separators can also be formed from polyesters, polyetherketones, poly(vinyl chloride), vinyl polymers, and substituted vinyl polymers. These can be used alone or in combination with any previously described polymer.

Porous separators are non-conductive membranes which allow charge transfer between two electrodes via open channels filled with electrolyte. The permeability increases the probability of active materials passing through the separator from one electrode to another and causing cross-contamination and/or reduction in cell energy efficiency. The degree of this cross-contamination can depend on, among other features, the size (the effective diameter and channel length), and character (hydrophobicity/hydrophilicity) of the pores, the nature of the electrolyte, and the degree of wetting between the pores and the electrolyte.

In some embodiments, the separator can also include reinforcement materials for greater stability. Suitable reinforcement materials can include nylon, cotton, polyesters, crystalline silica, crystalline titania, amorphous silica, amorphous titania, rubber, asbestos, wood or any combination thereof.

Separators within the flow batteries of the present disclosure can have a membrane thickness of less than about 500 micrometers, or less than about 300 micrometers, or less than about 250 micrometers, or less than about 200 micrometers, or less than about 100 micrometers, or less than about 75 micrometers, or less than about 50 micrometers, or less than about 30 micrometers, or less than about 25 micrometers, or less than about 20 micrometers, or less than about 15 micrometers, or less than about 10 micrometers. Suitable separators can include those in which the flow battery is capable of operating with a current efficiency of greater than about 85% with a current density of 100 mA/cm² when the separator has a thickness of 100 micrometers. In further embodiments, the flow battery is capable of operating at a current efficiency of greater than 99.5% when the separator has a thickness of less than about 50 micrometers, a current efficiency of greater than 99% when the separator has a thickness of less than about 25 micrometers, and a current efficiency of greater than 98% when the separator has a thickness of less than about 10 micrometers. Accordingly, suitable separators include those in which the flow battery is capable of operating at a voltage efficiency of greater than 60% with a current density of 100 mA/cm². In further embodiments, suitable separators can include those in which the flow battery is capable of operating at a voltage efficiency of greater than 70%, greater than 80% or even greater than 90%.

The diffusion rate of the first and second active materials through the separator can be less than about 1×10⁻⁵ mol cm⁻² day⁻¹, or less than about 1×10⁻⁶ mol cm⁻² day⁻¹, or less than about 1×10⁻⁷ mol cm⁻² day⁻¹, or less than about 1×10⁻⁹ mol cm⁻² day⁻¹, or less than about 1×10⁻¹¹ mol cm⁻² day⁻¹, or less than about 1×10⁻¹³ mol cm⁻² day⁻¹, or less than about 1×10⁻¹⁵ mol day⁻¹.

The flow batteries can also include an external electrical circuit in electrical communication with the first and second electrodes. The circuit can charge and discharge the flow battery during operation. Reference to the sign of the net ionic charge of the first, second, or both active materials relates to the sign of the net ionic charge in both oxidized and reduced forms of the redox active materials under the conditions of the operating flow battery. Further exemplary embodiments of a flow battery provide that (a) the first active material has an associated net positive or negative charge and is capable of providing an oxidized or reduced form over an electric potential in a range of the negative operating potential of the system, such that the resulting oxidized or reduced form of the first active material has the same charge sign (positive or negative) as the first active material and the ionomer membrane also has a net ionic charge of the same sign, and (b) the second active material has an associated net positive or negative charge and is capable of providing an oxidized or reduced form over an electric potential in a range of the positive operating potential of the system, such that the resulting oxidized or reduced form of the second active material has the same charge sign (positive or negative sign) as the second active material and the ionomer membrane also has a net ionic charge of the same sign; or both (a) and (b). The matching charges of the first and/or second active materials and the ionomer membrane can provide a high selectivity and help regulate crossover.

Flow batteries incorporating of the present disclosure can have one or more of the following operating characteristics: (a) where, during the operation of the flow battery, the first or second active materials comprise less than about 3% of the molar flux of ions passing through the ionomer membrane; (b) where the round trip current efficiency is greater than about 70%, greater than about 80%, or greater than about 90%; (c) where the round trip current efficiency is greater than about 90%; (d) where the sign of the net ionic charge of the first, second, or both active materials is the same in both oxidized and reduced forms of the active materials and matches that of the ionomer membrane; (e) where the ionomer membrane has a thickness of less than about 100 μm, less than about 75 μm, less than about 50 μm, or less than about 250 μm; (f) where the flow battery is capable of operating at a current density of greater than about 100 mA/cm² with a round trip voltage efficiency of greater than about 60%; and (g) where the energy density of the electrolyte solutions is greater than about 10 Wh/L, greater than about 20 Wh/L, or greater than about 30 Will.

In some cases, a user may desire to provide higher charge or discharge voltages than available from a single electrochemical cell. In such cases, several battery cells can be connected in series such that the voltage of each cell is additive. This forms a bipolar stack, also referred to as an electrothemical stack. A bipolar plate can be employed to connect adjacent electrochemical cells in a bipolar stack, which allows for electron transport to take place but prevents fluid or gas transport between adjacent cells. The positive electrode compartments and negative electrode compartments of individual cells can be fluidically connected via common positive and negative fluid manifolds in the bipolar stack. In this way, individual cells can be stacked in series to yield a voltage appropriate for DC applications or conversion to AC applications.

In additional embodiments, the cells, bipolar stacks, or batteries can be incorporated into larger energy storage systems, suitably including piping and controls useful for operation of these large units. Piping, control, and other equipment suitable for such systems are known in the art, and can include, for example, piping and pumps in fluid communication with the respective chambers for moving electrolyte solutions into and out of the respective chambers and storage tanks for holding charged and discharged electrolytes. The cells, cell stacks, and batteries of this disclosure can also include an operation management system. The operation management system can be any suitable controller device, such as a computer or microprocessor, and can contain logic circuitry that sets operation of any of the various valves, pumps, circulation loops, and the like.

In more specific embodiments, a flow battery system can include a flow battery (including a cell or cell stack); storage tanks and piping for containing and transporting the electrolyte solutions; control hardware and software (which may include safety systems); and a power conditioning unit. The flow battery cell stack accomplishes the conversion of charging and discharging cycles and determines the peak power. The storage tanks contain the positive and negative active materials, such as the coordination complexes disclosed herein, and the tank volume determines the quantity of energy stored in the system. The control software, hardware, and optional safety systems suitably include sensors, mitigation equipment and other electronic/hardware controls and safeguards to ensure safe, autonomous; and efficient operation of the flow battery system. A power conditioning unit can be used at the front end of the energy storage system to convert incoming and outgoing power to a voltage and current that is optimal for the energy storage system or the application. For the example of an energy storage system connected to an electrical grid, in a charging cycle the power conditioning unit can convert incoming AC electricity into DC electricity at an appropriate voltage and current for the cell stack. In a discharging cycle, the stack produces DC electrical power and the power conditioning unit converts it to AC electrical power at the appropriate voltage and frequency for grid applications.

Where not otherwise defined hereinabove or understood by one having ordinary skill in the art, the definitions in the following paragraphs will be applicable to the present disclosure.

As used herein, the term “energy density” will refer to the amount of energy that can be stored, per unit volume, in the active materials. Energy density refers to the theoretical energy density of energy storage and can be calculated by Equation 1:

Energy density=(26.8 A-h/mol)×OCV×[e⁻] (1)

where OCV is the open circuit potential at 50% state of charge, (26.8 A-h/mol) is Faraday's constant, and [e⁻] is the concentration of electrons stored in the active material at 99% state of charge. In the case that the active materials largely are an atomic or molecular species for both the positive and negative electrolyte, [e⁻] can be calculated by Equation 2 as:

[e⁻]=[active materials]×N/2 (2)

where [active materials] is the molar concentration of the active material in either the negative or positive electrolyte, whichever is lower, and N is the number of electrons transferred per molecule of active material. The related term “charge density” will refer to the total amount of charge that each electrolyte contains. For a given electrolyte, the charge density can be calculated by Equation 3

Charge density=(26.8 A-h/mol)×[active material]×N (3)

where [active material] and N are as defined above.

As used herein, the term “current density” will refer to the total current passed in an electrochemical cell divided by the geometric area of the electrodes of the cell and is commonly reported in units of mA/cm².

As used herein, the term “current efficiency” (I_{eff}) can be described as the ratio of the total charge produced upon discharge of a cell to the total charge passed during charging. The current efficiency can be a function of the state of charge of the flow battery. In some non-limiting embodiments, the current efficiency can be evaluated over a state of charge range of about 35% to about 60%.

As used herein, the term “voltage efficiency” can be described as the ratio of the observed electrode potential, at a given current density, to the half-cell potential for that electrode (×100%). Voltage efficiencies can be described for a battery charging step, a discharging step, or a “round trip voltage efficiency.” The round trip voltage efficiency (V_{eff,RT}) at a given current density can be calculated from the cell voltage at discharge (V_{discharge}) and the voltage at charge (V_{charge}) using equation 4:

V_{eff,RT}=V_{discharge}/V_{charge}×100% (4)

As used herein, the terms “negative electrode” and “positive electrode” are electrodes defined with respect to one another, such that the negative electrode operates or is designed or intended to operate at a potential more negative than the positive electrode (and vice versa), independent of the actual potentials at which they operate, in both charging and discharging cycles. The negative electrode may or may not actually operate or be designed or intended to operate at a negative potential relative to a reversible hydrogen electrode. The negative electrode is associated with a first electrolyte solution and the positive electrode is associated with a second electrolyte solution, as described herein. The electrolyte solutions associated with the negative and positive electrodes may be described as negolytes and posolytes, respectively.

In view of the foregoing, the present disclosure also provides methods for mitigating the effects of crossover in flow batteries and related electrochemical systems. More specifically, the methods can include: providing a first electrolyte solution containing a coordination complex as a first active material, where the coordination complex contains a redox-active metal center and an organic compound bound to the redox-active metal center; providing a second electrolyte solution containing an unbound form of the organic compound, or an oxidized or reduced variant thereof, as a second active material; disposing the first electrolyte solution and the second electrolyte solution on opposing sides of a separator in a flow battery; and operating the flow battery by reducing the redox-active metal center in the coordination complex and oxidizing the unbound form of the organic compound or the reduced variant thereof, or by oxidizing the redox-active metal center in the coordination complex and reducing the unbound form of the organic compound or the oxidized variant thereof.

In more specific embodiments, the present disclosure provides methods for mitigating crossover in flow batteries containing coordination complexes with catechol or substituted catechol ligands. More specifically, the methods can include: providing a first electrolyte solution containing a coordination complex as a first active material, where the coordination complex contains a redox-active metal center and an organic compound selected from at least catechol, a substituted catechol, or any combination thereof bound to the redox-active metal center; providing a second electrolyte solution containing an unbound form of the organic compound, or a quinone variant thereof, as a second active material; disposing the first electrolyte solution and the second electrolyte solution on opposing sides of a separator in a flow battery; and operating the flow battery by reducing the redox-active metal center in the coordination complex in the first electrolyte solution and oxidizing the catechol or substituted catechol in the second electrolyte solution to the quinone variant, or by oxidizing the redox-active metal center of the coordination complex in the first electrolyte solution and reducing the corresponding quinone variant in the second electrolyte solution to catechol or the substituted catechol.

In further embodiments, the methods of the present disclosure can further include allowing at least a portion of the coordination complex to cross the separator of the flow battery and enter the second electrolyte solution. Accordingly, in such embodiments, the methods of the present disclosure can further include degrading or disassociating the coordination complex to form additional catechol or substituted catechol, or the corresponding quinone variant thereof, in the second electrolyte solution. The conditions in the second electrolyte solution can be selected to promote degradation or disassociation, as discussed in more detail above.

In more specific embodiments, the first electrolyte solution can be present in a negative half-cell of the flow battery and the second electrolyte solution can be present in a positive half-cell of the flow battery. In some or other embodiments, the first electrolyte solution can have an alkaline pH value, and the second electrolyte solution can have an acidic pH value. More specific examples of suitable pH values for each electrolyte solution are discussed above. In more particular embodiments, the second electrolyte solution can have a pH at which the coordination complex degrades or disassociates to form catechol, a substituted catechol, or the corresponding quinone variant thereof in an unbound form.

The methods for operating the flow battery while mitigating the effects of active material crossover can be performed in conjunction with charging or discharging the flow battery. With the first electrolyte solution being present in the negative half-cell of the flow battery and the second electrolyte solution being present in the positive half-cell of the flow battery, discharging the flow battery can involve reducing the redox-active metal center of the coordination complex in the first electrolyte solution and oxidizing the unbound catechol or substituted catechol in the second electrolyte solution to the corresponding quinone. Correspondingly, in such a configuration, charging the flow battery can involve oxidizing the redox-active metal center in the coordination complex in the first electrolyte solution and reducing the corresponding quinone variant in the second electrolyte solution back to the unbound catechol or substituted catechol.

### Examples

FIG. 2 shows illustrative cyclic voltammograms of NaKTi(catecholate)₂(monosulfonated catecholate) and unbound monsulfonated catechol plotted in the same field. The monosulfonated catechol was 3,4-dihydroxybenzenesulfonic acid. The electrolyte solution containing NaKTi(catecholate)₂(monosulfonated catecholate) was maintained at a pH of 9.9 and also contained 0.14 M K₂CO₃ as a supporting electrolyte. The electrolyte solution containing the 3,4-dihydroxybenzenesulfonic acid was maintained at a pH of 3 and also contained 0.1 M Na₂SO₄ as a supporting electrolyte. The concentration of each active material was approximately 0.1 M and the scan rate was 0.01 V/s. As shown in FIG. 2, the voltammograms were well separated from one another and showed a cell potential of about 1.8 Volts.

Although the disclosure has been described with reference to the disclosed embodiments, those skilled in the art will readily appreciate that these are only illustrative of the disclosure. It should be understood that various modifications can be made without departing from the spirit of the disclosure. The disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description.

What is claimed is the following:

1. A flow battery comprising:
a first half-cell containing a first electrolyte solution, the first electrolyte solution comprising a coordination complex as a first active material;
wherein the coordination complex comprises a redox-active metal center and an organic compound bound to the redox-active metal center; and
a second half-cell containing a second electrolyte solution, the second electrolyte solution comprising an unbound form of the organic compound, or a corresponding oxidized or reduced variant thereof, as a second active material.

2. The flow battery of claim 1, wherein the redox-active metal center is a transition metal.

3. The flow battery of claim 1, wherein the organic compound lacks redox activity when bound to the redox-active metal center.

4. The flow battery of claim 1, wherein the organic compound comprises catechol, a substituted catechol, or any combination thereof.

5. The flow battery of claim 4, wherein the organic compound comprises at least a monosulfonated catechol.

6. The flow battery of claim 1, wherein the coordination complex comprises both Na⁺ and K⁺ counterions.

7. The flow battery of claim 1, wherein the first half-cell is a negative half-cell and the second half-cell is a positive half-cell.

8. The flow battery of claim 1, wherein the second electrolyte solution has a pH at which the coordination complex degrades or disassociates to form the unbound form of the organic compound, or the corresponding oxidized or reduced variant thereof.

9. A flow battery comprising:
a first half-cell containing a first electrolyte solution, the first electrolyte solution comprising a coordination complex as a first active material and the first half-cell being a negative half-cell;
wherein the coordination complex comprises a redox-active metal center and an organic compound comprising catechol, a substituted catechol, or any combination thereof bound to the redox-active metal center; and
a second half-cell containing a second electrolyte solution, the second electrolyte solution comprising an unbound form of the organic compound, or a corresponding quinone variant thereof, as a second active material and the second half-cell being a positive half-cell.

10. The flow battery of claim 9, wherein the redox-active metal center is titanium.

11. The flow battery of claim 9, wherein the redox-active metal center is a transition metal.

12. The flow battery of claim 11, wherein the coordination complex has a formula of
D_{g}M(L₁)(L₂)(L₃);
wherein M is the transition metal; D is NH₄⁺, Li⁺, Na⁺, K⁺, or any combination thereof; g ranges between 2 and 6; and L₁, L₂ and L₃ are ligands, at least one of L₁, L₂ and L₃ being catechol or the substituted catechol.

13. The flow battery of claim 12, wherein each of L₁, L₂ and L₃ is catechol or the substituted catechol.

14. The flow battery of claim 12, wherein at least one of L₁, L₂ and L₃ is a monosulfonated catechol.

15. The flow battery of claim 12, wherein the transition metal is titanium.

16. The flow battery of claim 9, wherein the organic compound comprises at least a monosulfonated catechol.

17. The flow battery of claim 9, wherein the coordination complex comprises both Na⁺ and K⁺ counterions.

18. The flow battery of claim 9, wherein the second electrolyte solution has a pH at which the coordination complex degrades or disassociates to form the unbound form of the organic compound, or the corresponding quinone variant thereof.

19. The flow battery of claim 9, wherein the first electrolyte solution has an alkaline pH and the second electrolyte solution has an acidic pH.

20. A method comprising:
providing a first electrolyte solution comprising a coordination complex as a first active material;
wherein the coordination complex comprises a redox-active metal center and an organic compound comprising catechol, a substituted catechol, or any combination thereof bound to the redox-active metal center;
providing a second electrolyte solution comprising an unbound form of the organic compound, or a corresponding quinone variant thereof, as a second active material;
disposing the first electrolyte solution and the second electrolyte solution on opposing sides of a separator in a flow battery; and
operating the flow battery by reducing the redox-active metal center of the coordination complex in the first electrolyte solution and oxidizing the catechol or substituted catechol in the second electrolyte solution to the corresponding quinone variant, or oxidizing the redox-active metal center of the coordination complex in the first electrolyte solution and reducing the corresponding quinone variant in the second electrolyte solution to catechol or the substituted catechol.

21. The method of claim 20, wherein at least a portion of the coordination complex crosses the separator and enters the second electrolyte solution, the method further comprising:
degrading or disassociating the coordination complex to form additional catechol or substituted catechol, or the corresponding quinone variant thereof, in the second electrolyte solution.

22. The method of claim 21, wherein the second electrolyte solution has a pH at which the coordination complex degrades or disassociates to form the unbound form of the organic compound.

23. The method of claim 21, wherein the first electrolyte solution is present in a negative half-cell of the flow battery and the second electrolyte solution is present in a positive half-cell of the flow battery.

24. The method of claim 20, wherein the redox-active metal center is titanium.
